(19) United States
(12) Patent Application Publication
(10) Pub. No.: US 2014/0358868 A1
(43) Pub. Date: Dec. 4, 2014

(54) LIFE CYCLE MANAGEMENT OF METADATA

(71) Applicant: International Business machines Corporation, Armonk, NY (US)

(72) Inventors: Jean-Marc Costecalde, Irvine, CA (US); Kevin N. Trinh, Garden Grove, CA (US)

(21) Appl. No.: 13/909,236

(22) Filed: Jun. 4, 2013

(51) Int. Cl. G06F 17/30

(52) U.S. Cl. CPC G06F 17/30303
USPC 707/692

(57) ABSTRACT

The program code assigns a first record to a first object having a first life cycle and a second record to a second object having a second life cycle, wherein the first object is associated to the second object, and wherein the assigning is based on configurable predefined rules. In response to receiving a request to perform a delete action on at least one of the first object and the second object, performing the delete action when the at least one of the first object and the second object has a life cycle that is in a destroy phase.

### BACKGROUND

1. Field of the Invention

The present invention relates generally to records management software programs, and more particularly to a record management software program having program code for managing a life cycle for metadata, wherein the life cycle for the metadata is separate from a life cycle for an object to which the metadata is associated.

2. Description of the Related Art

Records management software applications can provide security and life cycle management features to manage electronic documents (i.e., electronic files and/or electronic images) as records, which involves keeping metadata associated to the electronic documents and/or folders in synch with the content within the respective electronic documents and folders. For example, in a response to records management software application locking down or deleting content of an electronic document, metadata associated to the electronic document is also locked down or deleted. Content of an electronic document, and any metadata associated to the electronic document that is locked down cannot be deleted while locked down.

Many software applications are expanding ways in which metadata associated to electronic documents and/or folders is utilized. As result, software developers continue to explore ways for managing electronic documents and folders, as well as the metadata associated to them. Currently, many businesses as well as state and federal government agencies utilize computer software applications with functionality for managing an electronic document having an associated object, wherein the associated object can include metadata. The metadata can contain confidential information. In addition, more computer software applications are utilizing contentless objects. A contentless object is an object that exists in a repository without having any information (i.e., data) within the object. Thus, a contentless object can be a blank electronic document, or a folder. Metadata can be indexed and utilized to search for information within a database, and even to extract and update the information within the database. The value of metadata can diminish over time for one or more reasons such as quality or lack of use. Therefore, it is important for the metadata to be accurate to ensure that the correct information is being retrieved and/or extracted and updated. In light of the above, as more businesses as well as state and federal government agencies upgrade to computer software applications with functionality that relies heavily on metadata, securing the metadata from unauthorized access and managing the life cycle of the metadata, beginning from creation of the metadata and ending at the disposal of the metadata, is becoming increasingly important.

### SUMMARY

Aspects of an embodiment of the present invention disclose a method, computer system, and program product for managing a life cycle for metadata, wherein the life cycle for the metadata is separate from a life cycle for an object to which the metadata is associated. A computer assigns a first record to a first object having a first life cycle and a second record to a second object having a second life cycle, wherein the first object is associated to the second object, and wherein the assigning is based on configurable predefined rules. In response to receiving a request to perform a delete action on at least one of the first object and the second object, performing the delete action when the at least one of the first object and the second object has a life cycle that is in a destroy phase.

### BRIEF DESCRIPTION OF THE SEVERAL VIEWS OF THE DRAWINGS

The subject matter which is regarded as an embodiment of the present invention is particularly pointed out and distinctly claimed in the claims at the conclusion of the specification. One manner in which recited features of an embodiment of the present invention can be understood is by reference to the following detailed description of embodiments, taken in conjunction with the accompanying drawings in which:

FIG. 1 is a block diagram of a computer system with a server computer having a records management software program with a metadata management program module that includes program code for managing a life cycle for metadata, wherein the life cycle for the metadata is separate from a life cycle for an object to which the metadata is associated according to an embodiment of the present invention.

FIG. 2 is a diagram of the electronic document repository and the record repository according to an embodiment of the present invention.

FIGS. 3A and 3B are flowcharts illustrating operations of the program code according to an embodiment of the present invention.

FIG. 4 is a block diagram depicting internal and external components of the client computer and the server computers of FIG. 1 according to an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like, conventional procedural programming languages such as the “C” programming language, a hardware description language such as VERILOG, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Exemplary embodiments now will be described more fully herein with reference to the accompanying drawings. This disclosure may, however, be embodied in many different forms and should not be construed as limited to the exemplary embodiments set forth herein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

Embodiments of the present invention provide a records management software program with program code for managing a life cycle for metadata, wherein the life cycle for the metadata is separate from a life cycle for an object to which the metadata is associated. Specifically, to have a separate life cycle for metadata from the life cycle for an object to which the metadata is associated, the program code selectively assigns a record (e.g., database record) to the metadata, wherein the record is subsequently utilized by the program code to manage the life cycle for the metadata. As a result, by assigning a record to a metadata that is separate from a record assigned to an object to which the metadata is associated, the metadata will have its own life cycle that is separate from the life cycle for the object. In addition, a life cycle of a record assigned to an object is the life cycle of the object. For example, a record assigned to metadata has a life cycle that is also the life of the metadata.

Moreover, if a record is assigned to an object (e.g., metadata), then the object is in a lock down state and cannot be updated while in the lock down state without creating a new version of the object having a new record. Thus, if an end-user needs to update an old version of metadata to a new version of the metadata then the new version of the metadata must be created, and a new record must be assigned to the new version of the metadata. Subsequent to assignment of the new record to the new version of the metadata, the old version of the metadata can be deleted.

Furthermore, by assigning a record to a metadata that is separate from a record assigned to an object to which the metadata is associated, the metadata can exist for a shorter or longer period of time than the object. Accordingly, the metadata associated to the object (e.g., an electronic document) can be managed (e.g., deleted) independently of the object and any content (e.g., plain text) of the object. The object mentioned above can be a set of data, a folder, a file (i.e., an electronic document), or a directory within a computer file system hierarchy.

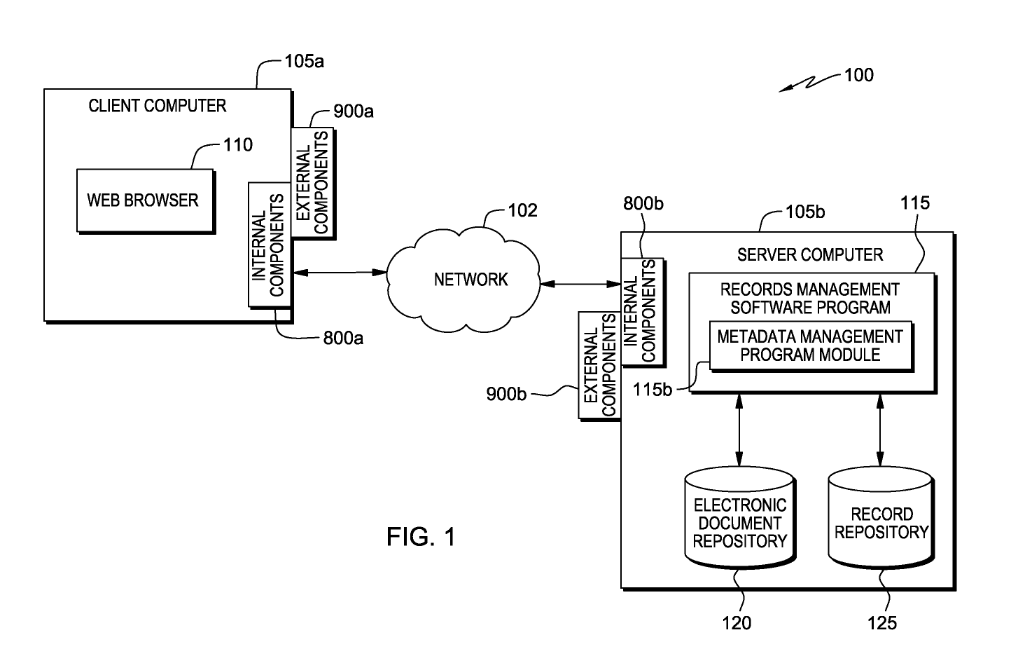

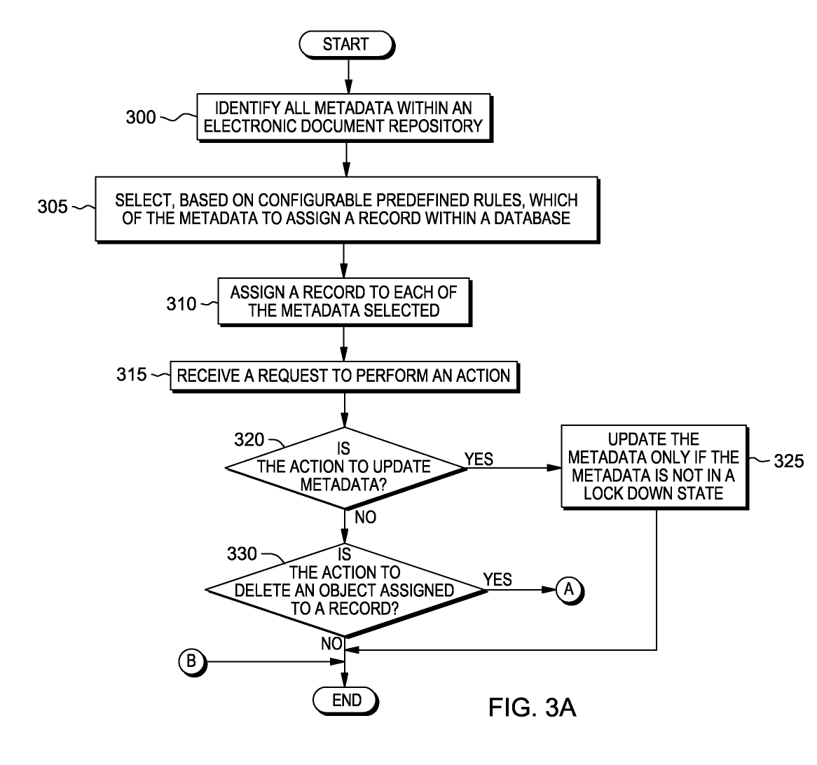

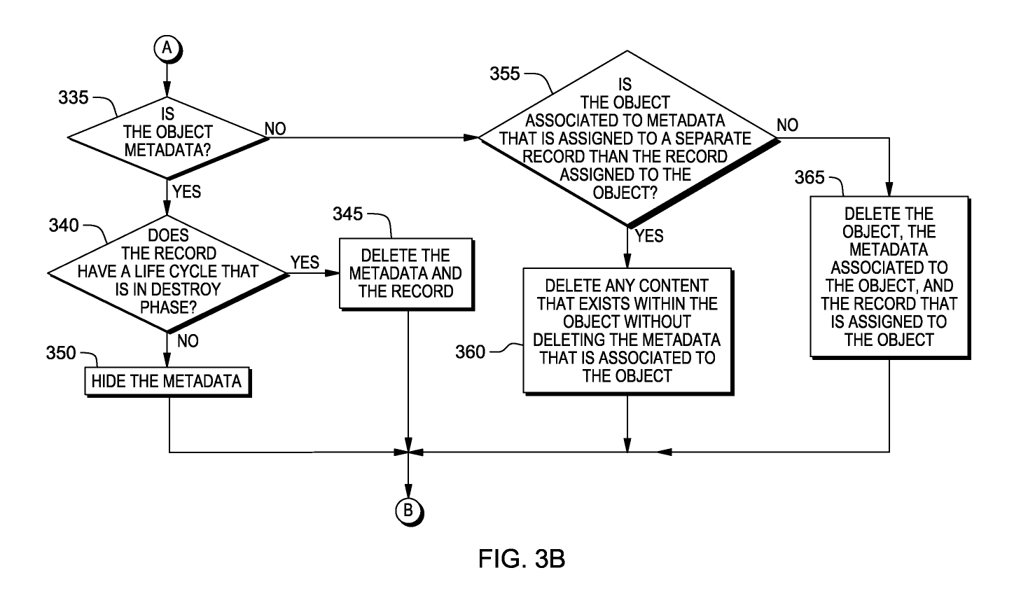

FIG. 1 illustrates computer system 100 that includes client computer 105a, server computer 105b, and network 102. Client computer 105a and server computer 105b each include respective internal components 800a and 800b, and respective external components 900a and 900b, as described below in more detail with respect to FIG. 3. Client computer 105a includes web browser 110 for remotely accessing a user interface of records management software program 115. Records management software 115 includes metadata management program module 115b, and interacts with electronic document repository 120 and record repository 125.

Electronic document repository 120 is a database for storing a computer file system hierarchy of objects (e.g., electronic documents and folders) and metadata. Specifically, the metadata can be associated to one or more objects within the computer file system hierarchy. Record repository 125 is a database for storing at least properties and rules utilized for managing record retention. Managing record retention includes managing the disposal of the objects and metadata within electronic document repository 120. The term disposal as used hereinafter refers to electronically transferring and/or deleting records and the objects assigned to the records. Electronic documents within electronic document repository 120 can include plaintext files, audio files, and video files. In addition, the electronic documents within electronic document repository 120 can include images in various image file formats such as the following: BMP, GIF, JPEG, PNG, TIFF, etc. The metadata within electronic document repository 120 can include various types of information (e.g., file name, file creation date, file size, folder name, unique location of a file within a computer file system hierarchy, folder creation date, and folder size) and even custom properties such as contract close date and employee hire date. Thus, the metadata can include information associated to individual electronic documents and/or the individual folders within a computer file system hierarchy that corresponds to a computer file system that is utilized by an operating system to organize and keep track of files (e.g., the electronic documents). Thus, the individual folders can contain one or more of the files. In the disclosed embodiment, repositories 120 and 125 both reside on server computer 105b. However, in other embodiments repositories 120 and 125 can each reside on separate computers.

Repositories 120 and 125 can each be configured to store data within fields having various data types that include: text, numeric, currency, data, memo, hyperlink, and object. Particularly, record repository 125 is a repository that includes a hierarchy of arranged folders, which includes sub-folders for classifying, organizing, and managing records associated to the objects and/or the metadata that reside in electronic document repository 120.

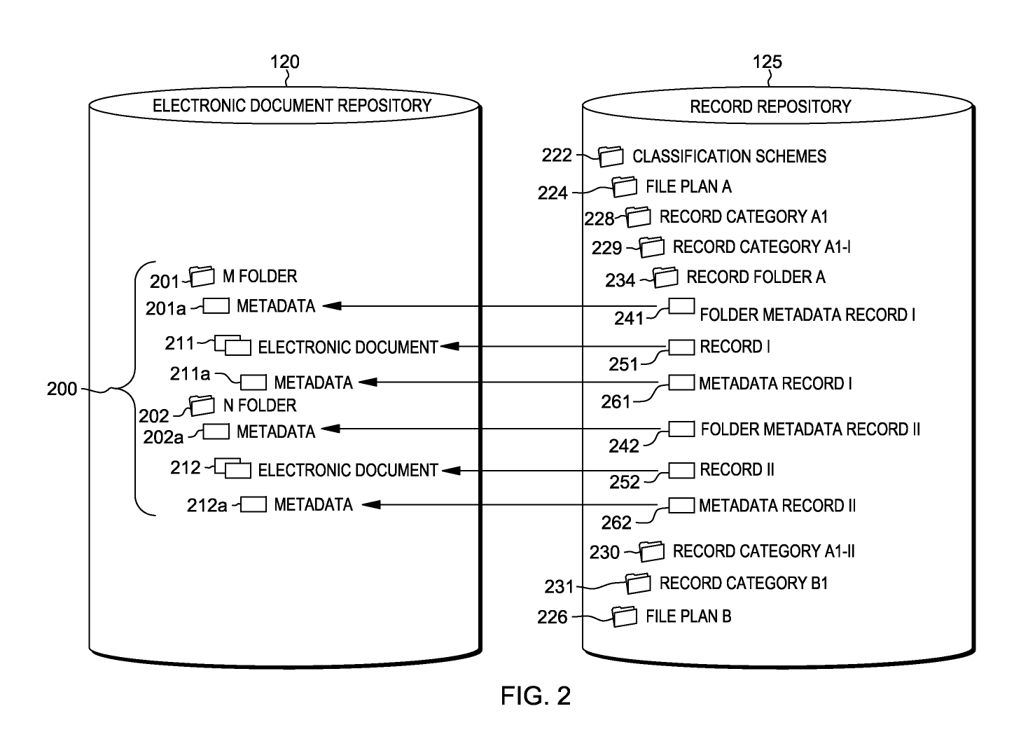

FIG. 2 is a diagram of electronic document repository 120 and record repository 125. In the disclosed embodiment, electronic document repository 120 is a database that stores computer file system hierarchy 200 of folders (i.e., M folder 201 and N folder 202), electronic documents 211 and 212, and metadata 201a, 202a, 211a, and 212a. Specifically, M folder 201 is associated to metadata 201a, and N folder 202 is associated to metadata 202a. Moreover, electronic document 211, within M folder 201, is associated to metadata 211a, and electronic document 212, within N folder 202, is associated to metadata 212a. Electronic document 211 and electronic document 212 can each have different information. In the disclosed embodiment, only two folders (i.e., M folder 201 and N folder 202) are shown, but in other embodiments computer file system hierarchy 200 may include only one folder or more than two folders with additional metadata and electronic documents corresponding to a more complex computer file system.

Record repository 125 is a hierarchy of arranged folders. The highest level folder in the hierarchy is classification schemes 222, wherein classification schemes 222 is utilized to organize file plan A 224 and file plan B 226. Specifically, classification schemes 222 has sub-folders that include file plan A 224 and file plan B 226 each utilized for defining a taxonomy of sub-folders (e.g., record categories and record folders) within record repository 125. In the disclosed embodiment, file plan A 224 includes the following sub-folders: record category A1 228, record category A1-I 229, record category A1-II 230, record category B1 231, and record folder A 234. Record folder A 234 includes the records discussed in further detail below. Record category A1 228 includes record category A1-I 229 and record category A1-II 230 as a sub-folders. Thus, a record category can include other record categories as sub-folders. In addition, in the disclosed embodiment, file plan B 226 does not include any sub-folders, but in other embodiments file plan B 226 can be configured to include sub-folders.

In addition to defining a taxonomy of sub-folders, record category A1 228, record category A1-I 229, record category A1-II 230, record category B1 231, and record folder A 234 can each be further utilized for declaring rules. The rules that are declared include rules for governing end-user role-based access to the records and/or metadata within electronic document repository 120. For example, record folder A 234 is utilized for declaring rules associated to the records that are briefly mentioned above and are discussed in further detail below. In addition, each of the records has a specified format that enables records management software program 115 to locate and access objects (e.g., electronic documents) and/or metadata within electronic document repository 120. The rules associated to the records can be declared within record folder A 234, or even within one of the other sub-folders mentioned above such as record category A1 228 or record category A1-I 229.

Furthermore, as mentioned above record repository 125 is a hierarchy of arranged folders, which includes sub-folders. The folders are utilized for classifying, organizing, and managing records such as folder metadata record I 241 that includes a value (e.g., address) that refers directly to metadata 201a, record I 251 that includes a value (e.g., address) that refers directly to electronic document 211, metadata record I 261 that includes a value (e.g., address) that refers directly to metadata 211a of electronic document 211, folder metadata record II 242 that includes a value (e.g., address) that refers directly to metadata 202a, record II 252 that includes a value (e.g., address) that refers directly to electronic document 212, and metadata record II 262 that includes a value (e.g., address) that refers directly to metadata 212a of electronic document 212.

In addition, each of the records and their assigned objects and/or metadata can each have a life cycle that is configurable to have characteristics that include various phases, wherein the life cycle typically refers to the lifespan of the record that starts from a phase for creating the record (i.e., creation phase), followed by one or more phase for maintaining the record (e.g., review phase, export phase, and destroy phase). Thus, a life cycle for a record assigned to the metadata is configurable to have characteristics that can include the creation phase, the review phase, the export phase, and/or the destroy phase. Transition of a life cycle for a record from a first phase (e.g., review phase) to a second phase (e.g., destroy phase) is trigger by the completion of the first phase. The creation phase refers to a period of time during which a new entry for a record assigned to metadata is made within record repository 125. The review phase refers to a period of time during which an end-user is to review information within a record and/or an object to which the record is assigned, and confirm the information within the record and/or the object is accurate. If the information within the record is not accurate then an action to update the information within the record may need to be performed. The export phase refers to extracting, transferring and/or archiving data (e.g., object and/or metadata) from a database (e.g., electronic document repository 120). For example, if the data is a plain text document, then the plain text document will be extracted during the export phase. The destroy phase refers to a period of time during which a record and metadata or an object assigned to the record can be deleted. Moreover, as mentioned above a record (e.g., record I 251) can include a value (e.g., address) that refers directly to an object (e.g., an electronic document 211), and even further include information (e.g., contract close date property that defines a point in time to delete the object) necessary to manage the retention of the object.

In the disclosed embodiment, the hierarchy of arranged folders within record repository 125 are also utilized for selectively managing a life cycle of a record assigned to either of electronic document 211, electronic document 212, metadata 201a, metadata 211a, metadata 202a, and metadata 212a. Specifically, because electronic document 211, metadata 201a, metadata 211a, electronic document 212, metadata 202a, and metadata 212a are each associated to their own record having a life cycle, as mentioned above, the program code of metadata management program module 115b can selectively manage the life cycle of each record wherein the life cycle of each record is also the life cycle an object to which each record is assigned to. As a result, a record assigned to metadata (e.g., metadata 201a, 211a, 202a, or 212a) can have a same or different life cycle than a record assigned to an object (e.g., an electronic document) to which the metadata is associated. For example, metadata record I 261 can have a same life cycle as record I 251. Alternatively, metadata record I 261 can have a different life cycle than record I 251.

In the disclosed embodiment, each record assigned to metadata (e.g., metadata 201a, 211a, 202a, or 212a) is stored in the same database (i.e., record repository 125) as each record assigned to an object to which the metadata is associated. However, in other embodiments, to enhance performance of accessing and performing operations on records, each record assigned to metadata (e.g., metadata 201a, 211a, 202a, or 212a) can be stored in a different database than a database that stores each record assigned to an object to which the metadata is associated. Furthermore, because the metadata (e.g., metadata 201a, 211a, 202a, or 212a) are each assigned to their own record, a set of rules can be selectively applied to each record assigned to the metadata. The selective application of the set of rules to each record that includes a value (e.g., address) that refers directly to the metadata (i.e., application of the set of rules to each record associated to the metadata), allows a system programmer/administrator to implement retention policies that govern how long the metadata is retained prior to disposal. Specifically, the rules can define how long a record assigned to metadata must be kept before disposal of the record and the metadata can occur. Some examples of rules include a rule to delete a record ten years after the employee's work contract expires, and a rule to review the record and/or the metadata (i.e., object) to which the record is assigned for three years and then delete the record and the metadata ten years after the employee's work contract expires. As mentioned above, the term disposal refers to electronically transferring and/or deleting the records and even electronic documents assigned to the records.

In the disclosed embodiment, as mentioned above, each record assigned to metadata (e.g., metadata 201a, 211a, 202a, or 212a) can have a life cycle, wherein the life cycle is configurable to have characteristics that include one or more of the following: a creation phase, a review phase, and a destroy phase. Subsequent to a record being assigned to metadata or to an object, the respective metadata or object and the record are in a lock down state. The lock down state refers to a period of time during which the record assigned to the metadata cannot be updated without assigning a new record to an updated version of the metadata. However, if the record assigned to an object has a life cycle that is in the destroy phase, then the record and the object can be deleted while in the lock down state. Therefore, if a first record assigned to an object has a life cycle that is in the destroy phase and the object is associated to metadata that is assigned to a second record, then the first record and the object itself may be deleted without deleting the metadata. Specifically, metadata to which the second record is assigned is not deleted unless the second record has a life cycle that is also in the destroy phase, because the metadata is in the lock down state as a result of the second record being assigned to the metadata. Accordingly, by assigning a record to metadata the life cycle for the metadata can be different than the life cycle for the object to which the metadata is associated.

FIGS. 3A and 3B are flowcharts illustrating the steps of program code, metadata management program module 115b, for selectively assigning a record to metadata, wherein the record assigned to the metadata is utilized by the program code to manage a life cycle for the record and the metadata, and wherein the life cycle for the metadata is separate from a life cycle for any object to which the metadata may be associated. As a result, the metadata can exist for a shorter or longer period of time than an object to which the metadata is associated. Moreover, the metadata can include various types of information related to the associated object such as, for example, the name of people, dates, and status identifiers that can be utilized by other computer software systems connected to computer system 100. In the disclosed embodiment, the program code identifies all metadata within electronic document repository 120 (block 300). For example, electronic document repository 120 can be a database in which metadata resides. Specifically, to identify all the metadata that is associated to an object the program code searches within each directory of a computer file system, that corresponds to computer file system hierarchy 200, for each object that is associated to metadata. The object can be a set of data, a folder, a file (e.g., an electronic document such as 211 or 212), metadata, or a directory within computer file system hierarchy 200. Next, in the disclosed embodiment the program code selects, based on configurable predefined rules, which of the metadata to assign a record within a database (block 305).

Thus, the configurable predefined rules are criteria that define the type of object (e.g., metadata) that the program code can assign a record to within record repository 125. For example, in an human resource system in which there is one folder per employee and the folder metadata includes a date property that can be set to a value representing the date when the employee's work contract expires, then the configurable predefined rules may include criteria that requires the program code to assign a record to the metadata having the date property set to any specified value other than null. Accordingly, the program code can assign a record to metadata that satisfies the configurable predefined rules, wherein the configurable predefined rules can be set by an end-user or a system programmer/administrator. Next, the program code assigns a record to each of the metadata selected (block 310). Thus, metadata associated to an object can be assigned to a record that is separate from a record assigned to an object to which the metadata can be associated. A record that is assigned to metadata results in the metadata being in a lock down state. Thus, the metadata and the record assigned to the metadata cannot be directly updated while in the lock down state, and can only be deleted if a life cycle for the record assigned to the metadata is in a destroy phase. Accordingly, even if a record assigned to an object is deleted and metadata in the lock down state is associated to the object, the metadata and a record assigned to the metadata will not be deleted unless a life cycle for the record assigned to the metadata is in the destroy phase.

Next, the program code receives a request to perform an action (block 315), and determines if the action is to update metadata (decision block 320). The request may be received from any computer software application that attempts to set a value to metadata. If the action is to update metadata (the “YES” branch of decision block 320), then the program code updates the metadata only if the metadata is not in a lock down state (block 325). Thus, if a record is assigned to the metadata, then the metadata is in the lock down state and the program does not update the metadata. However, if a record is not assigned to the metadata, then the program code updates the metadata. Subsequently, the program code ends.

However, if the action is not to update metadata (the “NO” branch of decision block 320), then the program code determines if the action is to delete an object assigned to a record (decision block 330). If the action is not to delete an object assigned to a record (the “NO” branch of decision block 330), then the program ends. However, if the action is to delete an object assigned to a record (the “YES” branch of decision block 330), then program code determines if the object is metadata (decision block 335). If the object is metadata (the “YES” branch of decision block 335), and if the record has a life cycle that is in destroy phase (the “YES” branch of decision block 340), then the program code deletes the metadata and the record (block 345). Subsequent to deleting the metadata and the record the program code ends. However, if the object is metadata (the “YES” branch of decision block 335), and if the record has a life cycle that is not in the destroy phase (the “NO” branch of decision block 340), then the program code hides the metadata (block 350). Specifically, the program code removes (i.e., deletes) the metadata if electronic document repository 120 allows such removal (i.e., if the record has a life cycle that is in destroy). Otherwise, if the metadata cannot be removed, then the program code can hide (i.e., blocks user interface viewing access to) the metadata while in the lock down state so that the metadata is inaccessible from any user interface through which an end-user may try to access the metadata. Subsequently, the program code ends.

Otherwise, if the object is not metadata (the “NO” branch of decision block 335), and if the object is associated to metadata that is assigned to a separate record than the record assigned to the object (the “YES” branch of decision block 355), then the metadata is in the lock down state and the program code deletes any content that exists within the object without deleting the metadata that is associated to the object (block 360). In the disclosed embodiment, content that exists within the object, as mentioned above, refers to information that is directly within the object. For example, if the object is a plain text file within which are pages of plain text, then the content that exists within the object refers to the pages of plain text. Therefore, the object becomes contentless and the program code ends. However, if the object is associated to metadata that is not assigned to a separate record than the record assigned to the object (the “NO” branch of decision block 355), then the program code deletes the object, the metadata associated to the object, and the record that is assigned to the object (block 365). Subsequently, the program code ends.

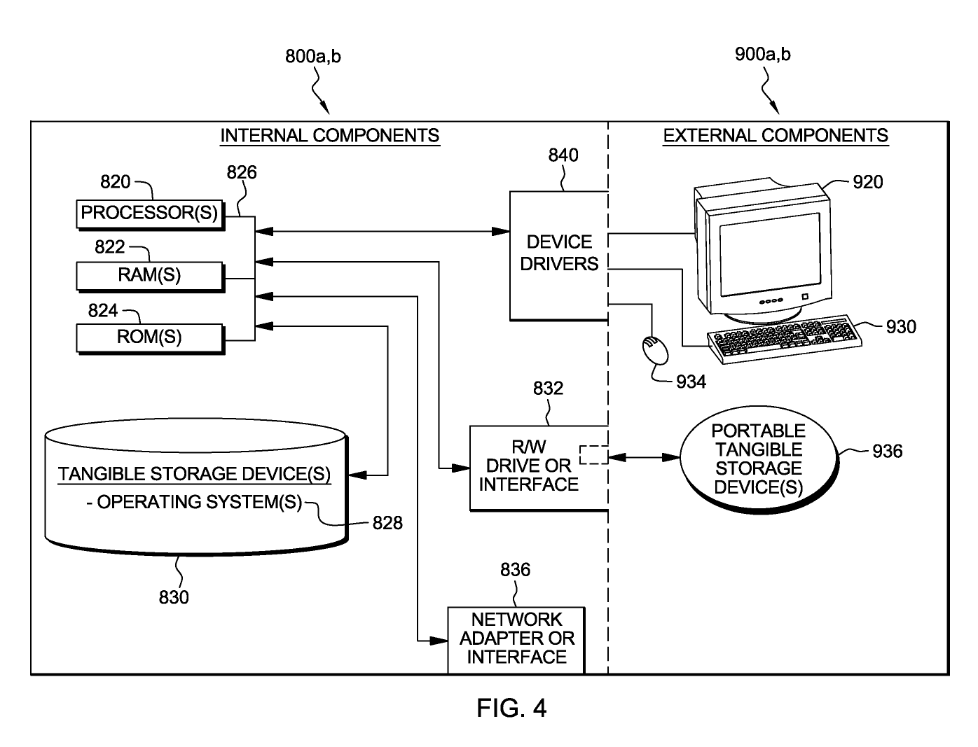

FIG. 4 is a block diagram depicting a set of internal components 800a and a set of external components 900a that correspond to respective client computer 105a, as well as a set of internal components 800b and a set of external components 900b that correspond to server computer 105b. Internal components 800a and 800b each include one or more processors 820, one or more computer readable RAMs 822 and one or more computer readable ROMs 824 on one or more buses 826, and one or more operating systems 828 and one or more computer readable tangible storage devices 830. The one or more operating systems 828 and metadata management program module 115b of records management software program 115 on server computer 105b are stored on one or more of the respective computer readable tangible storage devices 830 for execution by one or more of the respective processors 820 via one or more of the respective RAMs 822 (which typically include cache memory). In the embodiment illustrated in FIG. 4, each of the computer readable tangible storage devices 830 is a magnetic disk storage device of an internal hard drive. Alternatively, each of the computer readable tangible storage devices 830 is a semiconductor storage device such as ROM 824, EPROM, flash memory or any other computer readable tangible storage device that can store a computer program and digital information.

Each set of internal components 800a and 800b includes a R/W drive or interface 832 to read from and write to one or more portable computer readable tangible storage devices 936 such as CD-ROM, DVD, memory stick, magnetic tape, magnetic disk, optical disk or semiconductor storage device. Metadata management program module 115b on server computer 105b can be stored on one or more of the respective portable computer readable tangible storage devices 936, read via the respective R/W drive or interface 832 and loaded into the respective hard drive or computer readable tangible storage device 830.

Furthermore, each set of internal components 800a and 800b also includes a network adapter or interface 836 such as TCP/IP adapter card, wireless wi-fi interface card, or 3G or 4G wireless interface card or other wired or wireless communication link. Records management software program 115 with metadata management program module 115b can be downloaded to respective server computer 105b from an external computer or external storage device via a network (for example, the Internet, a LAN, or a WAN) and respective network adapters or interfaces 836. From the network adapter or interface 836, records management software program 115 with metadata management program module 115b on server computer 105b is loaded into at least one respective hard drive or computer readable tangible storage device 830. The network may comprise copper wires, optical fibers, wireless transmission, routers, firewalls, switches, gateway computers and/or servers.

Each set of external components 900a and 900b can include a computer display monitor 920, a keyboard 930, and a computer mouse 934. External components 900a and 900b can also include touch screens, virtual keyboards, touch pads, pointing devices, and other human interface devices. Each set of internal components 800a and 800b also includes device drivers 840 to interface to computer display monitor 920, keyboard 930 and computer mouse 934. The device drivers 840, R/W drive or interface 832 and network adapter or interface 836 comprise hardware and software in which the software is stored in computer readable tangible storage device 830 and/or ROM 824.

It should be appreciated that FIG. 4 provides only an illustration of one implementation and does not imply any limitations with regard to the environments in which different embodiments may be implemented. A variety of modifications to the depicted environments may be implemented. Moreover, a variety of modifications to the depicted environments may be made based on design and implementation requirements.

In accordance with the foregoing, a method, a computer system, and a computer program product have been disclosed for managing a life cycle for metadata, wherein the life cycle for the metadata is separate from a life cycle for an object to which the metadata is associated. As a result, the metadata of an object (e.g., electronic file) can be managed (e.g., updated and/or deleted) independently of the object and the content within the object. However, numerous modifications and substitutions can be made without deviating from the scope of an embodiment of the invention. Therefore, one or more embodiments of the invention have been disclosed by way of example and not limitation.

What is claimed is:

1. A computer implemented method comprising:
assigning a first record to a first object having a first life cycle and a second record to a second object having a second life cycle, wherein the first object is associated to the second object, and wherein the assigning is based on configurable predefined rules; and
in response to receiving a request to perform a delete action on at least one of the first object and the second object, performing the delete action when the at least one of the first object and the second object has a life cycle that is in a destroy phase.

2. The method of claim 1, wherein the assigning the first record comprises searching within each directory of a computer file system to identify the first object to which to assign the first record.

3. The method of claim 1, wherein the first life cycle is configurable to have characteristics that comprise at least a review phase to allow an end-user to review the first object, an export phase for at least extracting and transferring the first object from a database, and a destroy phase for deleting the first object and the first record.

4. The method of claim 1, wherein the first object is a metadata that comprises information associated to the second object, and wherein the information includes at least one of a file name, a file creation date, a file size, a folder name, a unique location of a file within a computer file system hierarchy, a folder creation date, and a folder size.

5. The method of claim 1, wherein the delete action comprises deleting the second object, without having to delete the first object.

6. The method of claim 1, wherein the delete action comprises hiding the first object, if the first object has a life cycle that is not in the destroy phase.

7. A computer program product comprising:
a computer readable storage medium and program instructions stored on the computer readable storage medium, the program instructions comprising:
program instructions to assign a first record to a first object having a first life cycle and a second record to a second object having a second life cycle, wherein the first object is associated to the second object, and wherein the program instructions to assign are based on configurable predefined rules; and
program instructions to perform a delete action based on receiving a request to perform the delete action on at least one of the first object and the second object, and based on when the at least one of the first object and the second object has a life cycle that is in a destroy phase.

8. The computer program product of claim 7, wherein the program instructions to assign the first record comprises program instructions to search within each directory of a computer file system to identify the first object to which to assign the first record.

9. The computer program product of claim 7, wherein the first life cycle is configurable to have characteristics that comprise at least a review phase to allow an end-user to review the first object, an export phase for at least extracting and transferring the first object from a database, and a destroy phase for deleting the first object and the first record.

10. The computer program product of claim 7, wherein the first object is a metadata that comprises information associated to the second object, and wherein the information includes at least one of a file name, a file creation date, a file size, a folder name, a unique location of a file within a computer file system hierarchy, a folder creation date, and a folder size.

11. The computer program product of claim 7, wherein the delete action comprises deleting the second object, without having to delete the first object.

12. The computer program product of claim 7, wherein the delete action comprises hiding the first object, if the first object has a life cycle that is not in the destroy phase.

13. A computer system comprising:
one or more processors, one or more computer readable memories, one or more computer readable storage media, and program instructions stored on the one or more storage media for execution by the one or more processors via the one or more memories, the program instructions comprising:
program instructions to assign a first record to a first object having a first life cycle and a second record to a second object having a second life cycle, wherein the first object is associated to the second object, and wherein the program instructions to assign are based on configurable predefined rules; and
program instructions to perform a delete action based on receiving a request to perform the delete action on at least one of the first object and the second object, and based on when the at least one of the first object and the second object has a life cycle that is in a destroy phase.

14. The computer system of claim 13, wherein the program instructions to assign the first record comprises program instructions to search within each directory of a computer file system to identify the first object to which to assign the first record.

15. The computer system of claim 13, wherein the first life cycle is configurable to have characteristics that comprise at least a review phase to allow an end-user to review the first object, an export phase for at least extracting and transferring the first object from a database, and a destroy phase for deleting the first object and the first record.

16. The computer system of claim 13, wherein the first object is a metadata that comprises information associated to the second object, and wherein the information includes at least one of a file name, a file creation date, a file size, a folder name, a unique location of a file within a computer file system hierarchy, a folder creation date, and a folder size.

17. The computer system of claim 13, wherein the delete action comprises deleting the second object, without having to delete the first object.

18. The computer system of claim 13, wherein the delete action comprises hiding the first object, if the first object has a life cycle that is not in the destroy phase.
